(19) United States
(12) Patent Application Publication
(10) Pub. No.: US 2011/0241935 A1
(43) Pub. Date: Oct. 6, 2011

(54) METHOD AND APPARATUS FOR IMPROVING GPS RECEIVER ACCURACY USING AN EMBEDDED MAP DATABASE

(76) Inventors: Srdjan Miocinovic, Santa Clara, CA (US); Mahesh Chowdhary, San Jose, CA (US)

(21) Appl. No.: 12/409,315

(22) Filed: Mar. 23, 2009

(51) Int. Cl. G01S 19/48

(52) U.S. Cl. 342/357.31

(57) ABSTRACT

The present invention is related to location positioning systems, and more particularly, to a method and apparatus for making accuracy improvements to a GPS receiver's navigation solutions. According to a first aspect, cartography information from a map database embedded within the GPS receiver is integrated into the position calculations performed by the GPS receiver. According to another aspect, the map database embedded within the GPS receiver is optimized for the purpose of improving the accuracy of the GPS receiver's position calculations.

### FIELD OF THE INVENTION

The present invention is related to location positioning systems, and more particularly, to a method and apparatus of improving navigation solutions by receivers in satellite positioning systems, such as GPS systems, by using an embedded map database.

### BACKGROUND OF THE INVENTION

With the development of radio and space technologies, several satellites based navigation systems (i.e. satellite positioning system or “SPS”) have already been built and more will be in use in the near future. SPS receivers, such as, for example, receivers using the Global Positioning System (“GPS”), also known as NAVSTAR, have become commonplace. Other examples of SPS systems include but are not limited to the United States (“U.S.”) Navy Navigation Satellite System (“NNSS”) (also known as TRANSIT), LORAN, Shoran, Decca, TACAN, NAVSTAR, the Russian counterpart to NAVSTAR known as the Global Navigation Satellite System (“GLONASS”) and any future Western European SPS such as the proposed “Galileo” program. As an example, the U.S. NAVSTAR GPS system is described in GPS Theory and Practice, Fifth ed., revised edition by Hofmann-Wellenhof, Lichtenegger and Collins, Springer-Verlag Wien New York, 2001, which is fully incorporated herein by reference.

The U.S. GPS system was built and is operated by the United States Department of Defense. The system uses twenty-four or more satellites orbiting the earth at an altitude of about 11,000 miles with a period of about twelve hours. These satellites are placed in six different orbits such that at any time a minimum of six satellites are visible at any location on the surface of the earth except in the polar region. Each satellite transmits a time and position signal referenced to an atomic clock. A typical GPS receiver locks onto this signal and extracts the data contained in it. Using signals from a sufficient number of satellites, a GPS receiver can calculate its position, velocity, altitude, and time.

In environments where satellite signals are degraded, however, a GPS receiver often encounters problems in locking onto the signals that are needed for the calculation of position, velocity, altitude, and time. In a degraded signal environment (e.g., a signal environment where signal strength is below 28 dBHz), satellite signals can be weak or otherwise difficult for GPS receivers to lock on to. One example of a degraded signal environment is a tunnel through which a car equipped with a GPS receiver is driving. While the GPS receiver is in the tunnel, the satellite signals are completely obstructed and no lock can be acquired. As a result, the GPS receiver cannot accurately calculate its position and other navigational data (such as velocity, altitude, and time) while the car is in the tunnel. In addition, because GPS receivers typically utilize positioning algorithms that use navigational filters that account for the GPS receivers' last-known positions, the GPS receiver's position calculation when the car emerges from the tunnel can also be less accurate since accurate position calculations were not performed during the time that the car was in the tunnel.

Degraded signal environments are often encountered in urban areas, such as cities with many tall buildings. A city with many tall buildings contain “urban canyons”, which are environments where streets cut through dense blocks of structures such as skyscrapers. In urban canyons, satellite signals are frequently not visible or are degraded due to the signals being partially or fully blocked by buildings, for example. Consequently, the problem of inaccurate position calculations by GPS receivers in degraded signal environments is especially acute in urban areas.

One way to improve the accuracy of a calculated GPS position is to make accuracy improvements with the aid of a map database. For example, personal navigation devices (PNDs) such as those available from Garmin and other manufacturers typically include extensive map databases covering entire countries or regions to provide real-time position displays and turn-by-turn directions among other things. Some attempts have been made to provide information from this map database back to the GPS receiver in real-time to aid in the receiver's navigation solution. However, this has been difficult to implement in practice because of the delays involved in the communications between the receiver and other PND components. For example, in order for information from the map database to aid in position calculations, feedback from the map database must be available within the time threshold for the next cycle of computation (usually within 250 ms or less for a GPS position update rate of one update per second). Another problem with this approach is that the accuracy improvements are limited because the accuracy improvements are performed only after the GPS position has already been calculated. Additionally, a common Application Programming Interface (APT) for providing map database feedback to position computation algorithms has to be supported by the various manufacturers of navigation systems and map database vendors.

Accordingly, a method and apparatus for making better accuracy improvements to a GPS receiver's position calculations in degraded signal environments remain desirable.

### SUMMARY OF THE INVENTION

The present invention is related to location positioning systems, and more particularly, to a method and apparatus for making accuracy improvements to a GPS receiver's navigation calculations. According to a first aspect, cartography information from a map database embedded within the GPS receiver is integrated into the navigation calculations performed by the GPS receiver. In this first aspect, cartography information from the embedded map database is used to adjust a parameter or parameters of a navigational filter in a positioning algorithm used by the GPS receiver. According to another aspect, the map database embedded within the GPS receiver is reduced to a size smaller than that of a typical map database in a Personal Navigation Device (PND) in a manner optimized for the purpose of improving the accuracy of the GPS receiver's navigation calculations.

In furtherance of these and other aspects, an exemplary method for reducing the size of a map database for embedding within a GPS receiver includes reducing or excluding cartography information, from the map database, for geographic regions that have been determined to not contain degraded signal environments. Other methods for reducing the size of a map database include reducing or excluding cartography information for geographic regions that are not urban areas and reducing or excluding map database elements and/or map database attributes that do not facilitate the determination of the GPS receiver's position.

In additional furtherance of the above and other aspects, an exemplary method for using cartography information from the embedded map database in a GPS receiver to adjust a navigational filter includes: obtaining location data derived from satellite signals received by the GPS receiver, using the embedded map database to find a matched road segment for the location data, and then using information about the matched road segment to adjust the navigational filter. An exemplary method for using the embedded map database to find a matched road segment for location derived from satellite signals includes: determining a confidence region based on the location data, extracting road segments in the confidence region, and evaluating the extracted road segments to select a matched road segment that is the road segment that is the best match for the location data. An exemplary method for using information about the matched road segment to adjust a navigational filter is to use the heading of the matched road segment to update the navigational filter. Another method is to derive a matched position on the matched road segment and to update the navigational filter based on the matched position. Yet another method includes detecting that the GPS receiver is at an intersection and updating the navigational filter with the location of the intersection.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram of an example implementation of principles of the invention;

FIG. 2 is a flowchart illustrating an example methodology for matching a location to a road segment that can be performed in accordance with aspects of the invention.

FIGS. 3A and 3B depict is a flowchart illustrating an example methodology for selecting a matched road segment that can be performed in accordance with aspects of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

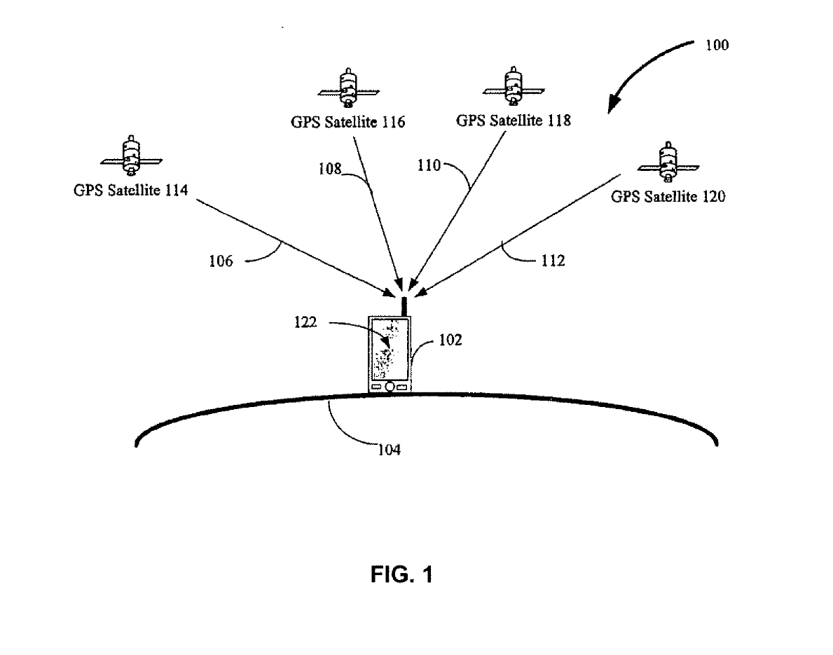

FIG. 1 illustrates an example implementation of embodiments of the invention. As shown in FIG. 1, GPS satellites (i.e. SVs) 114, 116, 118 and 120 broadcast signals 106, 108, 110 and 112, respectively, that are received by receiver 122 in handset 102, which is located at a user position somewhere relatively near the surface 104 of earth.

Handset 102 can be a personal navigation device (PND, e.g. from Garmin, TomTom, etc.) or it can be a cell or other type of telephone with built-in GPS functionality, or any GPS device embedded in tracking applications (e.g. automotive tracking from Trimble, package or fleet management tracking from FedEx, child locator tracking applications etc).

Receiver 122 can be implemented using any combination of hardware and/or software, including GPS chipsets such as SiRFstarIII GSD3tw or SiRFstar GSC3e from SiRF Technology and BCM4750 from Broadcom Corp., as adapted and/or supplemented with functionality in accordance with the present invention, and described in more detail herein. More particularly, those skilled in the art will be able to understand how to implement the present invention by adapting and/or supplementing such chipsets and/or software with the navigation solution improvement techniques of the present invention after being taught by the present specification.

In contrast to approaches where accuracy improvements are made after the GPS position has already been calculated, the present inventors recognize that better accuracy improvements can be made if cartography information from a map database is readily available to the position calculation function within the GPS receiver. More specifically, cartography information from the map database can be integrated with the navigational filter in the positioning algorithm used by the GPS receiver to calculate its position. Typical map databases, however, are located external to GPS receivers and it is currently not feasible for a GPS receiver to access an external map database at a sufficiently high speed to utilize the external map database's cartography information to make accuracy improvements in a manner integrated with the GPS receiver's positioning algorithm.

To achieve better accuracy improvements by integrating cartography information from a map database into a GPS receiver's positioning algorithm, the map database is embedded within the GPS receiver itself. An embedded map database can be accessed quickly and efficiently by the GPS receiver so that cartography information can be used in the real-time position calculations performed by the GPS receiver. In one embodiment, the embedded map database is stored in non-volatile (e.g. flash) memory that is readily accessible by the GPS receiver. In another embodiment, the embedded map database is stored in on-chip memory on the same chip as the GPS receiver. In yet another embodiment, a mechanism is set up on a host processor that has access to the map database to periodically send a small portion of the map database to the receiver. The portions of the map database sent to the receiver contain relevant cartography information for road segments in the vicinity of the current position of the receiver, and are used by the receiver in a mariner similar to how information from other embedded map databases are used, described in detail below.

Cartography information from the embedded map database is accessed and used within a GPS receiver's positioning algorithm in the calculation of the GPS receiver's position and velocity. More specifically, cartography information from the embedded map database is integrated with the navigational filter in the positioning algorithm. A parameter or several parameters of the navigational filter is adjusted based on cartography information from the embedded map database. The GPS receiver's position is then calculated using the navigational filter with the adjusted parameters. The accuracy of the GPS receiver's position calculation is improved through adjustments made to the navigational filter because the adjustments made are based on cartography information that is additional to the information the GPS receiver extracted from received satellite signals. In this manner, the position of a GPS receiver may be more accurately determined even in degraded signal environments where satellite signals are weak or are otherwise difficult to extract information from.

Further details regarding integrating cartography information from an embedded map database in a navigational filter in a GPS receiver's positioning algorithm are described in more detail below.

The embedded map database contains cartography information that includes information that defines networks of roads and associated attributes. Such cartography information is also typically contained in map databases in Personal Navigation Devices (PNDs), where the map databases are external to the GPS receivers in the PNDs. Map databases in PNDs, however, generally contain detailed cartography information for regions spanning a country or a continent and are consequently very large in size (at least several gigabytes). It may be impractical and inefficient to embed such large map databases wholesale into a GPS receiver for the purpose of improving the accuracy of the GPS receiver's position calculations. Therefore, according to one embodiment, the map database embedded on the GPS receiver is reduced to a size smaller than that of a typical map database in a PND in a manner optimized for the purpose of improving the accuracy of the GPS receiver's position calculations.

In embodiments, a map database embedded within a GPS receiver contains cartography information for geographic regions that likely to contain degraded signal environments. In a degraded signal environment, satellite signals are weak or otherwise difficult for use by GPS receivers to extract information from. Which geographic regions are likely to contain degraded signal environments may be determined beforehand. In some embodiments, the embedded map database may contain little or no cartography information on geographic regions other than the geographic regions that have been identified as likely to contain degraded signal environments, thereby reducing the size of the embedded map database. Since urban areas are likely to contain degraded signal environment due to the densely located and often tall buildings in urban areas, the embedded map database may contain cartography information only for urban areas. In one embodiment, the embedded map database contains cartography information only for a certain number of urban areas. For example, the embedded map database may only contain cartography information for the top fifty metropolitan areas in the United States.

In embodiments, a map database embedded within a GPS receiver contains cartography information that facilitates the determination of the position of the GPS receiver. A map database contains cartography information that includes information that defines networks of roads and associated attributes. For example, a map database may contain elements such as a node (a cross-point or endpoint of a road segment), a segment (a piece of road segment between two nodes that is used to represent fragments of roadway), a shape point (an ordered collection of points which map a curved portion of a road segment where the points are connected by consecutive segments of straight lines), and a three-dimensional structure (a structure that depicts a man-made object such as a building or a bridge). A map database element may also be associated with attribute(s) in a record. For example, a typical record for a node element contains attributes node Id, latitude, longitude, and connectivity. A record for a segment record may contain the attributes segment ID, left node, right node, length, shape points, directionality, speed limit, drivability, and city name.

The greater the number of elements contained in the embedded map database, the bigger the size of the map database. Similarly, the greater the number of attributes associated with elements contained in the embedded map database, the bigger the size of the map database. Therefore, in embodiments of the invention, the embedded map database may contain few or no elements other than elements that can be used to facilitate the determination of the GPS receiver's position, thereby reducing the size of the embedded map database. For example, a map database element that represents a building may not be useful for determining a GPS receiver's position. Accordingly, three-dimensional structure elements for buildings may be excluded from inclusion in an embedded map database. In a similar approach, the embedded map database may contain, for the elements in the embedded map database, few or no attributes other than attributes that can be used to facilitate the determination of the GPS receiver's position. For example, a speed limit attribute for a segment element may not be useful for position determinations and therefore may be excluded from inclusion in the embedded map database.

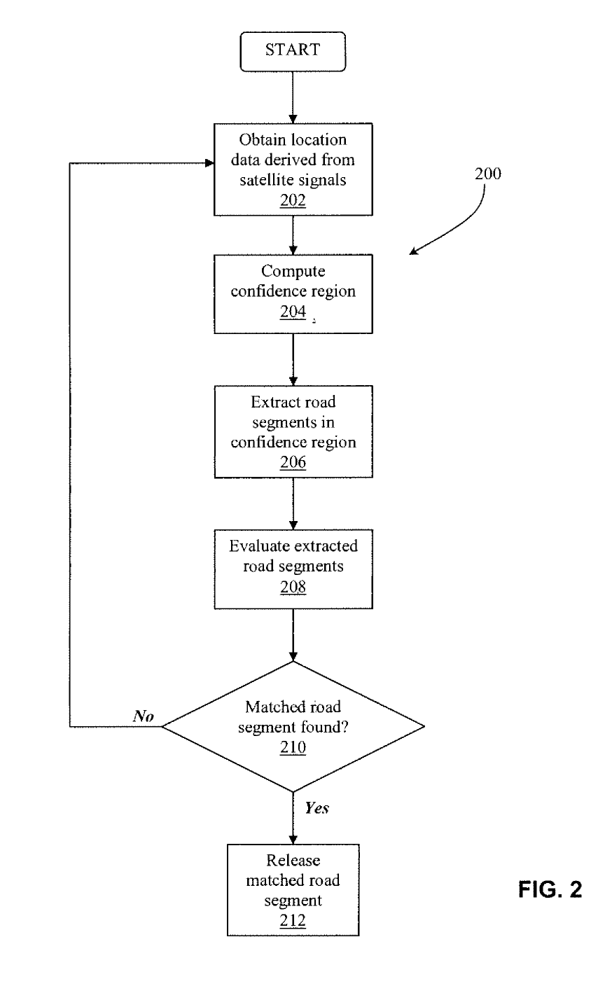

According to one embodiment, cartography information from a GPS receiver's embedded map database is integrated with the navigational filter used in the GPS receiver's positioning algorithm through a step of matching location data derived from satellite signals received by the GPS receiver to a matched road segment in the embedded map database. In this step, the GPS receiver first obtains location data derived from received satellite signals, then matches the location data to a “matched” road segment by using the cartography information contained in the embedded map database. This process of mapping location data to a road segment is also known as “map matching”, and the detailed steps of one example of a map matching process according to an embodiment of the invention are illustrated in flowchart 200 in FIG. 2, and will be described below.

Once map matching has been performed and a matched road segment has been identified, the matched road segment may be used in the GPS receiver's positioning algorithm. Specifically, information about the matched road segment may be used to adjust a parameter or parameters of a navigational filter used in the positioning algorithm. The details regarding how the matched road segment may be used to adjust the parameters of a navigational filter are more fully set forth after the map matching process descriptions below.

The following discussion describes in further detail each of the map matching steps illustrated in flowchart 200. It should be noted that other approaches for performing a map matching function, aside from the approach depicted in flowchart 200, will become apparent to those skilled in the art after being taught by the present disclosure. These may also be employed and the invention is not limited to any specific map matching process.

As shown in FIG. 2, in step 202, the GPS receiver obtains location data derived from received satellite signals. The derivation of location data may be performed using the GPS receiver's positioning algorithm without accessing any cartography information contained in the embedded map database or any other approaches for deriving location data from received satellite signals such as algorithms that employ the Kalman filter and/or the least squares method (the least squares method may also be used to initialize a Kalman filter). For ease of reference, the location indicated by the location data derived from received satellite signals will hereinafter also be referred to as “the initial uncorrected location”. Optionally, the GPS receiver may determine whether the initial uncorrected location lies within a geographic region for which the embedded database contains cartography information, and perform the remaining steps of the map matching process depicted in FIG. 2 (i.e. steps 204 et seq.) only if it is determined that the initial uncorrected location indeed lies within geographic region for which the embedded database contains cartography information.

Once the initial uncorrected location has been obtained, a confidence region may be computed (step 204). In embodiments, a confidence region is a region within which the actual position of the GPS receiver lies. A confidence region is also associated with a confidence level that indicates the level of certainty for the confidence region. For example, a confidence level of 89% indicates that there is a 89% probability that the actual position of the GPS receiver lies within the associated confidence region.

According to one embodiment, the confidence region for the initial uncorrected location is computed based on the parameters of a Kalman filter used in the GPS receiver's positioning algorithm. The Kalman filter produces a PVT (Position, Velocity, and Time) solution and associated error terms. Various implementations of a Kalman filter for GPS receivers can be found in M. Grewal et al., “Global Positioning Systems, Inertial Navigation, and Integration,” (2001), the contents of which are fully incorporated herein by reference. The measurement equation for this Kalman filter can be written as

Y=H·X

where Y is the known vector of measurements and X is state vector. The cofactor matrix P, where P=(H^{T}H)⁻¹ can be written as

$$P = [ \begin{matrix}{σ}_{x}^{2} & {σ}_{xy} & {σ}_{xz} & {σ}_{xt} \\ {σ}_{yx} & {σ}_{y}^{2} & {σ}_{yz} & {σ}_{yt} \\ {σ}_{zx} & {σ}_{zy} & {σ}_{z}^{2} & {σ}_{zt} \\ {σ}_{tx} & {σ}_{ty} & {σ}_{tz} & {σ}_{t}^{2}\end{matrix} ]$$

where σₓ², σ_{y}², σ_{z}² are the variances corresponding to the X, Y, Z positions and σ_{xy}², σ_{yz}², σ_{xz}², etc., are the covariances. These variance and covariance terms are produced by the Kalman filter for every PVT solution at a 1 Hz rate and can be used to compute an error ellipse that delineates the confidence region.

The error ellipse in a two-dimensional horizontal plane can be derived from

$$a = w \sqrt{\frac{1}{2} ( {σ}_{x}^{2} + {σ}_{y}^{2} + \sqrt{{( {σ}_{x}^{2} - {σ}_{y}^{2} )}^{2} + 4 {σ}_{xy}^{2}} )}$$

$$b = w \sqrt{\frac{1}{2} ( {σ}_{x}^{2} + {σ}_{y}^{2} - \sqrt{{( {σ}_{x}^{2} - {σ}_{y}^{2} )}^{2} + 4 {σ}_{xy}^{2}} )}$$

$$φ = \frac{π}{2} - {tan}^{- 1} ( \frac{2 {σ}_{xy}}{{σ}_{x}^{2} - {σ}_{y}^{2}} )$$

where a and b are the lengths of the semi-major and semi-minor axes of the error ellipse, respectively, Φ is the angle between the semi-major axis with respect to North, and w is the weighting factor pertaining to the confidence level of the confidence region delineated by the error ellipse. If normal distribution is assumed for measurement errors, then an error ellipse with a weighting factor w=1 would correspond to a 39% confidence level and w=103 would correspond to a 99% confidence level. As the weight of the confidence region, w, is varied, the number of road segments which could be considered for the map-matching search is correspondingly varied. A larger w indicates that location is known with a much higher confidence, but also indicates that the confidence region is larger in size and would therefore include a larger number of road segments that would need to be evaluated in the map-matching search.

Once the error ellipse is computed, it may be “superimposed” onto the cartography information stored in the embedded map database to derive the confidence region. Since this confidence region is delineated by an ellipse, the confidence region is also elliptical. Elliptical confidence regions may be difficult to work with, so according to another approach, rectangular confidence regions are computed. FIG. 4 depicts an elliptical error ellipse 402 with a semi-major axis 404 and semi-minor axis 406. As shown in FIG. 4, a is the length of the semi-major axis 404 and b is the length of the semi-minor axis 406. Angle Φ is the orientation of semi-major axis 404 with respect to North axis 408. In one approach, the rectangular confidence region 410 (with a length of 2a and a width of 2b) is determined to correspond to the elliptical confidence region 402. Other methods may be used to compute the corner points of a corresponding rectangular region.

After the confidence region has been computed, road segments within the confidence region are extracted (step 206). Road segments are segment elements stored in the embedded map database that represent fragments of roadway and may be associated with various attributes such as length and heading. Various algorithms may be employed to perform the extraction of road segments within a particular region, such as the Cyrus-Beck algorithm or the Cohen-Sutherland algorithm described in M. Agoston, “Computer Graphics and Geometric Modeling: Implementation and Algorithms,” (2005), the contents of which pertaining to these algorithms are incorporated herein by reference. The extracted road segments from the computed confidence region will hereinafter also be referred to as “the candidate road segments”.

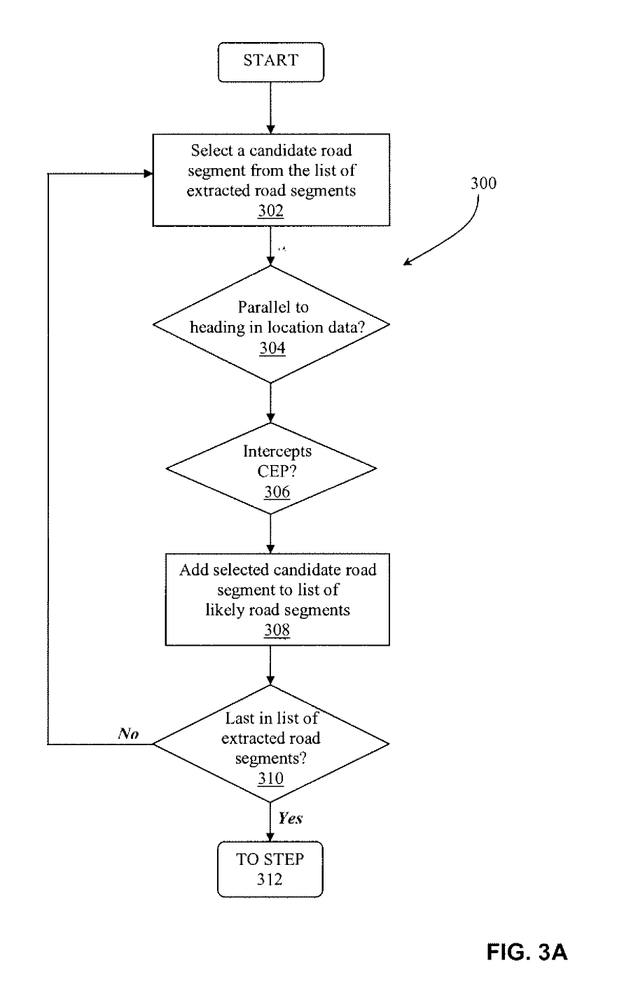

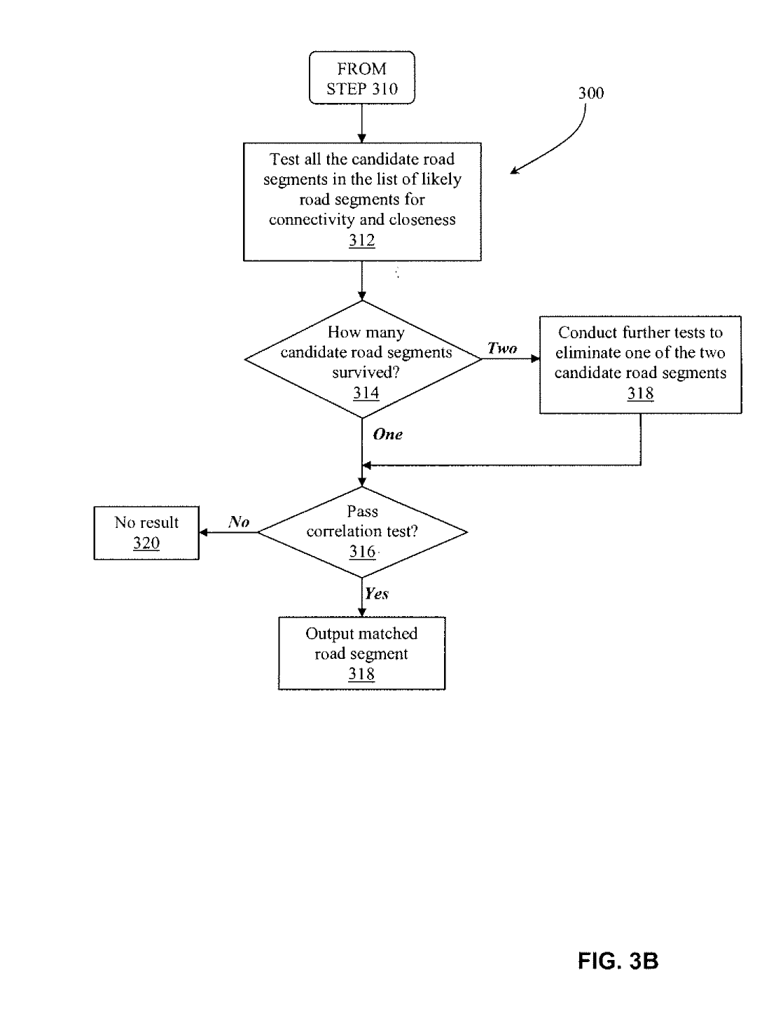

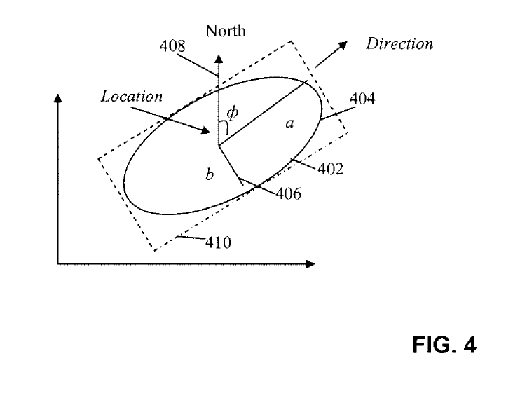

In step 208, various tests are performed on the candidate road segments to determine which candidate road segment is the matched road segment. The process for determining which candidate road segment is the matched road segment is described in further detail below and in connection with FIGS. 3A and 3B. A matched road segment is a road segment that is determined, based on the results of various tests, to be the most likely road segment on which the GPS receiver is located. A matched road segment is released to be used in the GPS receiver's positioning algorithm (steps 210 and 212). It may be, however, that none of the candidate road segments is determined to be a matched road segment because none of the candidate road segments satisfactorily passed all the tests. In such a case, no road segments are released as the matched road segment, and the steps of 202, 204, 206, and 208 are performed again based on a new set of received satellite signals (step 210).

According to one embodiment, the determination of a matched road segment, if any, from a set of at least one candidate road segment, is performed according to the steps illustrated in flowchart 300 in FIGS. 3A and 3B. The steps in flowchart 300 can correspond to step 208 in flowchart 200 (FIG. 2), and illustrate an example approach for determining a matched road segment. It should noted that other approaches for determining a matched road segment, aside from the approach depicted in flowchart 300, will become apparent to those skilled in the art after being taught by the present disclosure. These may also be employed and the invention is not limited to any specific process for selecting a matched road segment.

In step 302 of flowchart 300, a candidate road segment is selected from the list of candidate road segments extracted in step 206 of flowchart 200. The selected candidate road segment is subject to a first test in step 304 that determines whether the selected candidate road segment is parallel to a heading indicated by the location data derived from received satellite signals within a pre-determined threshold. For example, the location data derived from the received satellite signals may indicate that a heading of 75 degrees and the heading associated with the candidate road segment is 79 degrees. In this example, if the pre-determined threshold is 4 degrees or more, then the selected candidate road segment will be determined to have passed the first test. If the selected candidate road segment passes the first test in step 304, it is subject to a second test in step 306. If the selected candidate road segment does not pass the first test in step 304, however, then step 302 is performed and a new candidate road segment is selected for testing.

In step 306, whether the selected candidate road segment intercepts a contour of equal probability (CEP) is determined. A CEP is the region in which the GPS position for the current cycle of computation is known with the particular confidence level (e.g., 39%, 65%, 99%, etc.). Details regarding CEP regions may be found in Parkinson, B. W., Spilker, J, J., “Global Positioning System: Theory and Applications”, Vol. 1, American Institute of Aeronautics and Astronautics, 1996. A search can be conducted in the CEP region to find road segments in the map database that intercept the CEP region. If the selected candidate road segment passes the test in step 306 (i.e., the selected candidate road segments intercepts the CEP), it is added to a list of likely road segments (step 308). If the selected candidate road segment does not pass the test in step 306, however, then step 302 is performed and a new candidate road segment is selected for testing.

The candidate road segments in the list of extracted candidate road segments are subject to the tests of steps 304 and 306 until all the candidate road segments in the list of extracted candidate segments are exhausted (step 310). At this point, the list of likely road segments contains all the candidate road segments that have passed both the test in step 304 (for parallelism) and the test in step 306 (for CEP interception).

Next, all the candidate road segments in the list of likely road segments are subject to a connectivity test and a closeness test (step 312). The connectivity test determines if a particular candidate road segment is connected to a road segment that was previously determined to be the matched road segment (“previous matched road segment”). If no candidate road segments in the list of likely road segments are connected to the road segment that was the previous matched road segment, then it is determined that no candidate road segment is found to be the matched road segment (step 320). If more than one candidate road segment is found to be connected to the previous matched road segment, a closeness test is conducted. The closeness test is based on comparing the shortest distance from a particular “connected” candidate road segment to the previous matched road segment. No more than two candidate road segments are allowed to survive the tests in step 312. In other words, if there are three or more “connected” candidate road segments, then the two closest “connected” candidate road segments are deemed to have survived.

In step 314, it is determined whether zero, one or two candidate road segments survived the connectivity and closeness tests of step 312. If only one candidate road segment survived, then the one candidate road segment is subject to a correlation test in step 316. In a correlation test, an algorithm calculates the correlation function between the receiver trajectory and certain segments that include the most probable segment and segments connected to the most probable segment, where the most probable segment has the highest value of an associated certainty determined by the matching process. If the one candidate road segment passes the correlation test, then this one candidate road segment is output as the matched road segment (step 318), and is released to be used in the GPS receiver's positioning algorithm (step 212). If the one candidate road segment does not pass the correlation test, then it is determined that no candidate road segment is found to be the matched road segment (step 320). As discussed above, if no candidate road segment is found to be a matched road segment (step 210), then the steps of 202, 204, 206, and 208 of flowchart 200 are performed again based on a new set of received satellite signals.

If two candidate road segments survive the tests in step 312, then the two candidate road segments are subject to further tests to determine which of the two candidate road segment is a better match (step 322). One further test that may be conducted on the two candidate road segments is a trajectory matching test. In a trajectory matching test, trajectory data comprising a short history of the distances traveled and headings during 1 Hz updates is compared to the distances and headings of the two candidate road segments during the same period, and the candidate road segment whose distance and heading more closely matches the distances and headings in the short history is selected as in step 322. After only one candidate road segment remains after 322, the one candidate road segment is subject to the same correlation test discussed above in determining whether the one candidate road segment is a matched road segment.

After map matching has been performed and a matched road segment has been identified, the matched road segment may be used in the GPS receiver's positioning algorithm to improve the accuracy of the initial uncorrected location. According to one embodiment, information about the matched road segment is used to adjust a parameter or parameters of a navigational filter used in the positioning algorithm, which is then used by the GPS receiver to calculate a more accurate position.

In one possible approach, the navigation filter is a Kalman filter, and at least one measurement of the Kalman filter is updated based on a heading of the matched road segment. After the Kalman filter is updated, the GPS receiver uses the updated Kalman filter to determine a more accurate position of the GPS receiver.

In this approach, the heading of the matched road segment is used as a measurement for a Kalman filter (KALMAN FILTER) measurement update. The certainty associated with the matched road segment is the confidence level of the confidence region and may be used as a weight for the measurement update. The relationship between the heading measurement and the KALMAN FILTER's state vector is characterized as:

$$θ = {tan}^{- 1} ( \frac{{V}_{N}}{{V}_{E}} )$$

where θ is the heading measurement, V_{N} is the North velocity component, V_{E} is the East velocity component, and

$$H = \{ 0 , 0 , 0 , {θ}_{N}^{′} , {θ}_{E}^{′} , 0 , 0 , 0 \} , \\ {θ}_{N}^{′} = \frac{\partial θ}{\partial {V}_{N}}$$

$$and$$

$${θ}_{E}^{′} = \frac{\partial θ}{\partial {V}_{E}}$$

Furthermore, the heading measurement update from the matched road segment may be applied only when the GPS receiver's velocity is greater than a particular velocity threshold, such as 3 msec. Additionally or alternatively, the heading measurement update from the matched road segment may be applied only when the certainty associated with the matched road segment is above a particular certainty threshold, such as 90%. Both the velocity threshold and the certainty threshold may also be adjustable.

In another possible approach, the navigation filter is a Kalman filter, and a state vector of the Kalman filter is updated based on a matched position on the matched road segment, where the matched position is determined based on the trajectory of the GPS receiver.

In this approach, a short history of distances traveled by the GPS receiver along with corresponding headings (i.e. receiver trajectory) during 1 Hz update periods is stored temporarily in the local memory of the GPS receiver. Then, a correlation function computation algorithm is used to compute the function between the receiver trajectory and road segments in the vicinity of the initial uncorrected location, including the matched road segment and the segments connected to the matched road segment. If the result of the correlation function passes certain design thresholds, the matched road segment and the corresponding point on the matched road segment (i.e. matched position) can be used to determine a more accurate position of the GPS receiver. For example, the result from the correlation test can be normalized to a value between 0 and 100, and a threshold may be set to 66. This threshold is tunable and may be adjusted to other numbers.

To compute the matched position on the matched road segment, the total distance traveled between the last position update and the current GPS position update is computed. If the matched road segment is the same road segment as the previous matched road segment, then the matched position is determined to be the previous matched position advanced in the heading direction on the matched road segment. If the matched road segment is different from the previous matched road segment, then the distance traveled on the previous road segment is subtracted from the total distance traveled, and the difference is determined to be the distance traveled on the matched road segment. The matched position is then determined to be the position on the matched road segment that corresponds to the distance traveled on the matched road segment. In this approach, the matched position is provided as a measurement update for the horizontal position elements of the state vector of the KALMAN FILTER. The vector used as the measurement update contains unity terms corresponding to the horizontal position components and zeros for rest of the elements in state vector.

Furthermore, terms corresponding to uncertainty for the horizontal position elements in the R matrix (measurement noise matrix) of the Kalman filter may also be updated with the uncertainty of the matched position. The uncertainty of the matched position is in turn based on factors such as how often the matched positions and headings in previous updates closely correlate with computed GPS positions and headings, and whether the computed locations and updates match with road segment information in the map database when the receiver turns. Uncertainty is computed for each possibility of map-matched position with the new GPS filter data. Updating the R matrix ensures that the Kalman filter covariance update also accounts for the increased accuracy of the matched position.

In yet another approach, the navigation filter is a Kalman filter, and a state vector of the Kalman filter is updated based on an intersection position. In urban canyon environments, the view of the sky is limited by buildings such that the list of visible satellites for a GPS receiver usually only contain satellites directly above and the along the longitudinal direction of travel of the GPS receiver. When the GPS receiver is located in an intersection, however, additional satellites in the lateral direction become visible. This event of detecting more visible satellites in the lateral direction may be correlated to the position of the intersection in the embedded map database. A map database attribute may be stored for this correlation.

The intersection position may be provided as a measurement update for the horizontal position elements of the state vector of the KALMAN FILTER. The vector used as the measurement update contains unity terms corresponding to the horizontal position components and zeros for rest of the elements in state vector. Furthermore, terms corresponding to uncertainty for the horizontal position elements in the R matrix (measurement noise matrix) of the Kalman filter may also be updated with the uncertainty of the intersection position.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for determining a position of a GPS receiver, the method comprising:
at the GPS receiver:
based on cartography information stored in a map database embedded within the GPS receiver, adjusting at least one parameter of a filter that is used in a positioning algorithm; and
determining the position of the GPS receiver by using the positioning algorithm.

2. A method according to claim 1, wherein the map database includes cartography information for geographic regions that have been determined to be regions in which at least one satellite signal received by the GPS receiver is degraded.

3. A method according to claim 1, wherein the map database includes cartography information only for a pre-determined number of metropolitan geographic regions.

4. A method according to claim 1, wherein:
the map database contains at least one map database element;
the at least one map database element is associated with at least one attribute; and
the at least one attribute associated with the at least one map database element facilitates the determination of the position of the GPS receiver.

5. A method according to claim 4, wherein:
the at least one map database element is a node; and
the at least one attribute is one of latitude, longitude, and connectivity.

6. A method according to claim 4, wherein:
the at least one map database element is a road segment; and
the at least one attribute is one of left node, right node, and length.

7. A method according to claim 1, wherein the step of adjusting the at least one parameter of the filter includes:
matching location data derived from satellite signals received by the GPS receiver to a matched road segment in the map database; and
adjusting the at least one parameter of the filter based on information associated with the matched road segment in the map database.

8. A method according to claim 7, wherein the step of matching further includes:
determining a geographic region that includes a location indicated by the location data; and
determining whether the map database contains cartography information for the geographic region.

9. A method according to claim 7, wherein the step of matching includes:
determining, based on the location data derived from satellite signals received by the GPS receiver, a confidence region;
extracting, based on cartography information contained in the map database, a set of road segments that are located within the confidence region; and
selecting the matched road segment from the set of road segments.

10. A method according to claim 9, wherein the confidence region is elliptical.

11. A method according to claim 9, wherein the confidence region is rectangular.

12. A method according to claim 9, wherein the step of selecting the matched road segment from the set of road segments includes:
for each road segment in the set of road segments, performing the steps of:
determining whether the each road segment is parallel to a heading indicated by the location data within a pre-determined parallel range;
in response to determining that the each road segment is parallel to the heading indicated by the location data within the pre-determined range, determining whether the each road segment intercepts a contour of equal probability error region that contains a location indicated by the location data;
in response to determining that the each road segment intercepts the contour of equal probability error region that contains the location indicated by the location data, determining whether the each road segment is connected to another road segment that is a previously determined matched road segment;
in response to determining that the each road segment is connected to the other road segment that is a previously determined matched road segment, determining whether the each road segment is close to the other road segment within a pre-determined closeness range;
in response to determining that the each road segment is close to the other road segment within the pre-determined closeness range, determining that the each road segment satisfies a first test.

13. The method according to claim 12, further including the steps of:
determining whether more than one road segment in the set of road segments satisfy the first test;
in response to determining that no more than one road segment in the set of road segments satisfies the first test, determining whether the road segment that satisfies the first test passes a correlation test;
in response to determining that the road segment that satisfies the first test passes the correlation test, determining that the road segment is the matched road segment.

14. The method according to claim 13, further including the steps of:
in response to determining that more than one road segment in the set of road segments satisfy the first test:
determining whether more than one road segment in the set of road segments satisfy at least one other test;
in response to determining that no more than one road segment in the set of road segments satisfy the at least one other test, determining whether the road segment that satisfies the at least one other test passes a correlation test;
in response to determining that the road segment that satisfies the at least one other test passes the correlation test, determining that the road segment is the matched road segment.

15. The method according to claim 14, wherein the at least one other test includes a trajectory matching test.

16. A method according to claim 7, wherein:
the filter is a Kalman filter; and
the step of adjusting the at least one parameter of the filter based on information associated with the matched road segment in the map database includes the steps of:
updating at least one measurement of the Kalman filter based on a heading of the matched road segment;
determining, based on the at least one measurement of the Kalman filter, the position of the GPS receiver.

17. A method according to claim 16, wherein the step of updating is performed only if a certainty associated with the matched road segment exceeds a pre-determined certainty threshold.

18. A method according to claim 16, wherein the step of updating is performed only if a velocity of the GPS receiver exceeds a pre-determined velocity threshold.

19. A method according to claim 7, wherein:
the filter is a Kalman filter; and
the step of adjusting the at least one parameter of the filter based on information associated with the matched road segment in the map database includes the steps of:
determining a matched position on the matched road segment based on a receiver trajectory;
updating, based on the matched position, a state vector of the Kalman filter; and
determining, based on the state vector of the Kalman filter, the position of the GPS receiver.

20. A method according to claim 19, wherein the receiver trajectory is computed from data that indicates at least one previously traveled distance and associated heading.

21. A method according to claim 19, wherein the step of updating the state vector of the Kalman filter is performed only if a correlation between the receiver trajectory and the matched road segment exceeds a pre-determined threshold.

22. A method according to claim 19, wherein the step of determining the position of the GPS receiver based on information associated with the matched road segment in the map database further includes the step of:
updating a measurement noise matrix of the Kalman filter based on a certainty associated with the matched position.

23. A method according to claim 1, wherein:
the filter is a Kalman filter; and
the step of adjusting the at least one parameter of the filter based on information associated with the matched road segment in the map database includes the steps of:
detecting, based on which satellites are visible, that the GPS receiver is located at a particular intersection;
determining, based on cartography information stored in the map database, an intersection position associated with the particular intersection; and
updating a state vector of the Kalman filter based on the intersection position.

24. A method for determining a position of a GPS receiver, the method comprising:
identifying cartography information that facilitates the determination of a position of a GPS receiver; and
storing the cartography information on a map database embedded within the GPS receiver;
wherein the GPS receiver determines the position of the GPS receiver by using the cartography information stored in the map database embedded within the GPS receiver.

25. A device that performs the method of claim 1.

26. A device that performs the method of claim 3.

27. A device that performs the method of claim 7.

28. A device that performs the method of claim 9.

29. A device that performs the method of claim 16.

30. A device that performs the method of claim 19.

31. A device that performs the method of claim 23.

32. A device that performs the method of claim 24.
